(19) United States
(12) Patent Application Publication
(10) Pub. No.: US 2007/0016918 A1
(43) Pub. Date: Jan. 18, 2007

(54) Detecting and tracking advertisements

(76) Inventors: Allan E. Alcorn, Portola Valley, CA (US); James Cooper, Seattle, WA (US); Gary S. Fletcher JR., Auburn, CA (US); Tim Kay, Los Altos, CA (US); Mark D. Klein, Los Altos, CA (US); David Alan Whittemore, Woodland, CA (US); Tom Zito, Sausalito, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/438,089

(22) Filed: May 18, 2006

Related U.S. Application Data
(63) Continuation-in-part of application No. 11/216,543, filed on Aug. 30, 2005.
(60) Provisional application No. 60/683,228, filed on May 20, 2005.

(51) Int. Cl. H04N 7/16; H04H 9/00

(52) U.S. Cl. 725/22; 725/19; 725/18

(57) ABSTRACT

Audible media among different channels is recorded and analyzed to identify repeated instances of the same media item, either within a channel or from channel to channel, over a span of time. Such media items are identified as possible advertisements. A verification process is performed to determine which of these advertisement candidates are in fact advertisements. Once advertisements are so identified, audio from various sources is monitored to identify subsequent occurrences of that advertisement by matching the monitored audio against the stored signatures. In such a manner, advertisement flighting (broadcasts) as well as user exposure to advertisements can be detected and tracked.

### CROSS-REFERENCE TO RELATED APPLICATIONS

The present application claims priority from U.S. Provisional patent application Ser. No. 60/683,228, for “Detecting and Tracking Advertisements,” filed May 20, 2005, attorney docket number 10422, the disclosure of which is incorporated herein by reference.

The present application is a continuation-in-part of U.S. Utility patent application Ser. No. 11/216,543, for “Detecting and Measuring Exposure to Media Content Items,” filed Aug. 30, 2005, attorney docket number 10389, the disclosure of which is incorporated herein by reference.

### BACKGROUND

“Flighting” is defined as the planned and delivered impressions for an advertisement, including impressions from both broadcast and non-broadcast sources. Advertisers and advertising agencies want to know, as quickly as possible, whether their advertisements have been flighted on the stations and at the times they have booked. Additionally, advertisers and their agencies would like to know, in advance of their own media spend, the advertising patterns of competitors in particular markets.

However, gathering station logs and verifying that an advertisement ran is a time-consuming and paper-based process. Because of the burden of gathering and summarizing such information, advertisers often do not know whether and/or when their media has run until after their campaign is over.

In addition, because of the time delay, it is often impossible for an advertiser or agency to get an up-to-the-minute picture of competitors' advertising spending in a given market. This lack of information makes it difficult or impossible to purchase station time that will deliver messaging that is most effective against competitors' advertising.

It is also useful for advertisers to obtain information as to consumers' actual exposure to advertisements. Thus, in addition to finding out when and on what channels advertisements were broadcast, advertisers would also like to be able to find out the demographics and other characteristics of users (potential consumers) that were actually exposed to the advertisements.

What is needed is a system and method for quickly and accurately determining when and how often an advertisement has been flighted, and on which channels the flighting took place. What is further needed is a system and method for determining actual user exposure to advertisements, and demographic characteristics of those users that were exposed to the advertisements. What is further needed is a system and method for delivering results of such determinations in a timely and reliable manner.

### SUMMARY OF THE INVENTION

The system of the present invention tracks and identifies audible media being broadcast in a given market, and compares data among different channels to identify repeated instances of the same media item, either within a channel or from channel to channel, over a span of time. Such media items are identified as possible advertisements, because advertisements are a particular type of content that is often repeated in this manner. A verification process is performed to determine which of these advertisement candidates are in fact advertisements. The verification process can include, for example, an operator listening to and tagging the candidates to identify the product being advertised, the advertiser, and possibly other information.

Signatures for identified advertisements are stored in a database. Then, audio from various sources can be monitored to identify subsequent occurrences of that advertisement by matching the monitored audio against the stored signatures. In one embodiment, audio coming from media sources is monitored and matched against stored signatures so as to identify flighting of advertisements at those media sources. In another embodiment, audio is monitored at mobile client devices (MCDs) that are carried by or associated with users, and matched against stored signatures, so that user exposure to advertisements can be measured.

The system of the present invention therefore allows advertisers and their agencies to monitor flighting and exposure of their own advertisements and to be alerted to new campaigns that are being launched by competitors. Advertisers and analysts can monitor specifics as to channels and frequency for campaigns run by any entity, including competitors. The system can also measure advertisement exposure among users (potential consumers) carrying mobile client devices.

### BRIEF DESCRIPTION OF THE DRAWINGS

The accompanying drawings illustrate several embodiments of the invention and, together with the description, serve to explain the principles of the invention.

FIG. 1 is a block diagram depicting an overall architecture for implementing the present invention according to one embodiment.

FIGS. 2A through 2C are block diagrams depicting alternative methodologies for practicing the present invention.

FIG. 3 is a block diagram depicting an architecture for detecting and tracking advertisements according to one embodiment of the present invention.

FIG. 4A is a flowchart depicting a method for detecting and tracking advertisements by comparison with broadcast audio signatures according to one embodiment of the present invention.

FIG. 4B is a flowchart depicting a method for detecting and tracking advertisements by comparison with signatures obtained from mobile client devices according to one embodiment of the present invention.

FIG. 5A is a flowchart depicting a method for identifying advertisements by detecting multiple instances of media items within media data signature storage, according to one embodiment of the present invention.

FIG. 5B is a flowchart depicting a method for identifying advertisements by detecting multiple instances of media items within mobile client device data signature storage, according to one embodiment of the present invention.

FIG. 6 is a block diagram depicting various mechanisms for identifying, detecting, and tracking advertisements according to various embodiments of the present invention.

One skilled in the art will recognize that these Figures are merely examples of the operation of the invention according to one embodiment, and that other architectures and modes of operation can be used without departing from the essential characteristics of the invention.

### DETAILED DESCRIPTION OF THE EMBODIMENTS

For purposes of the following description, the terms “user” and “consumer” are synonymous and are used interchangeably.

The present invention is now described more fully with reference to the accompanying Figures, in which several embodiments of the invention are shown. The present invention may be embodied in many different forms and should not be construed as limited to the embodiments set forth herein. Rather these embodiments are provided so that this disclosure will be complete and will fully convey the invention to those skilled in the art.

### Overall Architecture

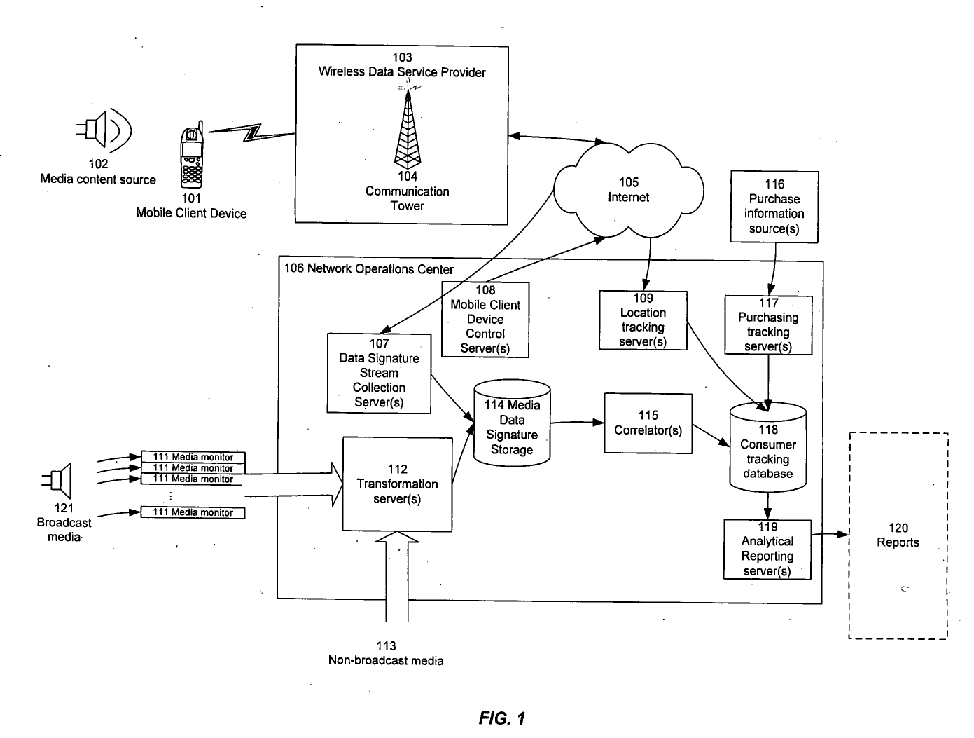

Referring now to FIG. 1, there is shown an architecture for implementing the present invention according to one embodiment.

A mobile client device (“MCD”) 101 carried by a user digitally samples the audio environment of the user on a regular basis. These samples are transformed into a stream of data signatures and transmitted to a network operations center (“NOC”) 106.

The MCD 101 may be built into a consumer device with some other utility to the user; examples include a mobile phone, PDA, wristwatch, or the like (“hosting device”). In alternative embodiments, the MCD 101 can take any other form, such as a standalone device that is carried by or attached to the user. Embedding the functionality of the present invention in a device such as a mobile phone or wristwatch makes it more convenient for a user to carry the MCD 101, and also encourages the user to keep the MCD 101 in his or her possession at all times. The MCD 101 operates passively and requires no user input.

The MCD 101 may have sensors to help determine if it is in the possession of a person. Sensors may include: vibration, state of the Hosting Device (on/off, usage, key presses, etc.), temperature (to detect whether the MCD 101 is being carried, since it will be proximate to or in contact with the person's body), and others. In situations where the user has agreed to carry the MCD 101 for tracking purposes, information from these sensors is processed to assist in determining a user's compliance with their obligations. If data is received at a time period when evidence indicates the device is not being carried, the received data may be discarded or treated as having a lower degree of reliability, or it may be otherwise flagged.

The MCD 101 can make use of already-present components (such as a microphone in a cell phone) to implement the operations described herein. The MCD 101 can transmit the data to the NOC 106 using any known wireless (or wired) communication method; such transmission can take place in real-time, or in a batched mode at periodic intervals, or in response to NOC 106 queries to the MCD 101. In one embodiment, such transmission can take place via GPRS, TCP/IP, SMS, or other mechanisms. In one embodiment, the user “docks” or connects the MCD 101 to a computer or other device in order to transmit data to the NOC 106.

At the NOC 106, the data signature stream is correlated against a set of data signature streams transformed from candidate audio sources, and stored in Media Data Signature Storage 114, to determine which candidate audio source, if any, the user is listening to at any given time. Time stamps stored with the data signatures aid in the correlation.

MCD 101 location information can be collected and used to assist in the correlation. Location data can be analyzed and compared with location databases to determine entry into a store or other location, time spent in the location, speed of travel, presence at a public venue (movie theater, concert hall, stadium), and other attributes that may be of commercial value when combined with media exposure data. For example, in one embodiment, location information is used to detect when a user takes a car for a test drive by tracking the entry into a car dealership, an average wait time, and a circuit of automobile-speed motion ending back at the dealership. Similarly, a lower probability of TV viewing can be inferred while the user is moving. MCD 101 location information can also be used to analyze listening behavior; for example, the user watches news at home and listens to music in the car. MCD 101 location information can also be used to infer user purchasing behavior; for example, the user visits a movie theater after listening to an advertisement for one of the movies playing at that theater.

In one embodiment, MCD 101 location is determined by built-in or added-in GPS, by triangulation with wireless data provider transceiver sites, by closest tower identification, by wireless data network registration (Bluetooth, WiFi/802.11), or by other means.

Media monitors 111 receive broadcast media 121 such as television and radio; this audio (or a sample of it) is recorded and transformed into signatures 402. Transformation server(s) 112 transform this audio (or a sample of it) into signatures that are stored in media data signature storage 114 along with time stamp information.

Signatures are stored in storage 114 along with appropriate indexing mechanisms to facilitate retrieval and comparison. Mobile client devices 101 detect user exposure to media content sources 102, for example by picking up audio at a microphone of a cell phone. This audio is recorded and transformed into signatures. These signatures are also stored. At a Network Operations Center (NOC) 106, the MCD signatures are compared with signatures derived from the broadcast audio, so as to detect and identify media items to which the user has been exposed. In this manner, the present invention is able to determine, with great specificity, which media items a user has been exposed to, and the particulars of such exposure (including number of repetitions, location of exposure, correlation to buying behavior, and the like). GPS or other location data can also be used in analyzing the media exposure, using known techniques such as those described in U.S. Pat. No. 6,970,131 to Percy et al. for “Satellite Positioning System Enabled Media Measurement System and Method” and U.S. Pat. No. 7,038,619 to Percy et al. for “Satellite Positioning System Enabled Media Measurement System and Method”.

From this correlation and analysis, reports are generated 408 and output. The present invention thus provides a mechanism for determining degrees of penetration and effectiveness for media content items such as advertisements. In addition, since users carry MCDs with them, the system of the present invention is able to detect exposure at any location, include within the home and outside the home.

Media content source 102 is any source to which a user may be exposed. Examples include television, radio, CDs, movies, public address announcements, and the like. According to the techniques described herein, the present invention tracks user exposure to various media content items that may come from any number of sources 102.

Mobile client device (MCD) 101 is a device capable of detecting and receiving audio from source 102. Any number of MCDs 101 can be provided; for example, in one embodiment each user being tracked has an MCD 101. In one embodiment, each MCD 101 is a device (or a component of a device) carried by a user (consumer). For example, MCD 101 may be built into a consumer device with some other utility to the user, such as a mobile phone, personal digital assistant (PDA), wristwatch, handheld computer, or the like. In one embodiment, MCD 101 includes a GPRS platform for transmitting data, and runs an operating system such as Microsoft Windows Mobile or J2ME. In alternative embodiments, MCD 101 can take any other form, such as a standalone device that is carried by or attached to the user. Embedding the functionality of the present invention in a device such as a mobile phone or wristwatch makes it more convenient for a user to carry MCD 101, and also encourages the user to keep MCD 101 in his or her possession at all times.

Although the description provided herein makes use of the term “MCD”, it will be recognized by one skilled in the art that the detection devices need not be mobile; in other words, the present invention can be implemented using stationary devices that perform essentially the same function as described herein.

In one embodiment, MCD 101 makes use of already-present components (such as a microphone in a cell phone) to implement the operations described herein.

MCD 101 operates passively and requires no user input. In one embodiment, MCD 101 digitally samples the audio environment of the user on a regular basis; in another embodiment, MCD 101 performs such sampling when it detects that meaningful audio has been received at MCD 101. MCD 101 transforms the audio samples to a data signature stream that can be digitally transmitted and/or stored. The audio content items received by MCD 101 are referred to herein as target media items.

In one embodiment, signature transformation is performed at MCD 101 in order to minimize the data to be uploaded to the network operations center (NOC) 106 and to ensure privacy and confidentiality. In one embodiment, some information is lost during the transformation, so that the transformation is a one-way process; raw data cannot be reconstructed from the transformed data signature. Transmitting transformed data, as opposed to raw data, thus provides a measure of privacy and confidentiality.

MCD 101 creates a raw audio file (such as a .WAV file) from the sampled data, and performs a signature transformation to generate a signature file from the raw audio file. Any of a number of signature algorithms can be used. In one embodiment, the system of the present invention uses a signature transformation algorithm that meets design constraints of MCD 101 (processing power, battery life, available memory) and the transmission channel (bandwidth, availability, and the like).

In one embodiment, MCD 101 may place itself into a quiescent (“sleeping”) state when the detected audio level drops below a threshold, so as to lessen battery drain). During this sleeping state, the MCD 101 periodically wakes up and determines if the audio level is sufficient to resume sampling.

In another embodiment, MCD 101 continually samples for N seconds every M seconds and then processes the audio content to make a judgment via frequency analysis/power levels as to its useful audio content before passing it on to the audio fingerprint process. If the audio content is judged to be not sufficient relevant given current power levels, then the sample is discarded so as to save processing and transmission time and thus conserving battery usage.

In one embodiment, the MCD 101 samples 10 seconds of audio data per 30 seconds received. Such a ratio is particularly effective for detecting exposure to commercials (advertisements), since many such commercials are at least 30 seconds long. Advertisements shorter than 30 seconds, which might take place between sampled audio, are detected according to techniques described below.

In another embodiment, MCD 101 does not do any transforming; rather it merely sends raw data.

MCD 101 transmits data to data signature stream collection server(s) 107 at Network Operations Center (NOC) 106. In one embodiment, this transmission takes place via wireless data service provider 103 which operates communication towers 104 that receive signals from MCD 101 and relay the sampled audio data via the Internet 105 to one or more data signature stream collection servers 107 running at NOC 106. One skilled in the art will recognize that this data transmission can take place using any known wireless (or wired) communication method, and that such transmission can take place in real-time, or in a batched mode at periodic intervals, or in response to NOC 106 queries to MCD 101. In one embodiment, such transmission can take place via GPRS, TCP/IP, or other mechanisms, or any combination thereof. In one embodiment, the user “docks” or connects MCD 101 to a computer or other device (not shown) in order to transmit data to NOC 106.

In one embodiment, signature files are transmitted to data signature stream collection server(s) 107 on a periodic basis (for example, every five minutes). However, if a connection cannot be made, or if power at MCD 101 is low, transfers of signature files can be delayed as long as is necessary. In one embodiment, individual MCDs 101 are capable of spooling (temporarily storing) some quantity of signature data so as to account for temporary inability to transmit to server(s) 107. If a prolonged period of time takes place when data cannot be transferred, so that an MCD 101 cannot spool additional incoming data, MCD 101 can temporarily stop collecting data. Alternatively, MCD 101 can discard old data in favor of new data. In one embodiment, once data has been transferred to server 107, MCD 101 clears its local storage (spool) in order to make room for new data.

In one embodiment, MCD 101 does not perform any transfers of target media items when its battery power is less than some threshold amount such as 50%, unless a) it is being charged; or b) its spool space is close to being full. In one embodiment, MCD 101 stops receiving and sampling data from media content sources 102 when its battery power is less than some second threshold amount such as 10%.

In one embodiment, a single data signature stream collection server 107 is used. In another embodiment, a plurality of servers 107 are used, and transmissions of data from MCDs 101 are directed to an appropriate server 107 for receipt, based on current load, geographic location, and/or other factors.

At NOC 106, data signature stream collection server 107 receives data from MCD 101 and stores it in data signature stream store 114 (also referred to as a dynamic database). Correlator server 115 correlates the data signature stream against a set of data signature streams transformed from candidate media sources to determine which candidate media source, if any, the user is listening to at any given time. In one embodiment, correlator server 115 uses a correlation algorithm as described in Avery Li-chun Wang, “An Industrial-Strength Audio Search Algorithm,” October 2003, and Avery Li-Chun Wang and Julius O. Smith, III, WIPO publication WO0211123A3, 7 Feb. 2002, “Method for Search in an Audio Database.”

The signature algorithm is able to correlate a user data signature stream against a potentially large number of candidate data signature streams. Once a match is found, it can be presumed the match continues for some period of time. In one embodiment, therefore, when a match is found, it is “locked on to” and no other candidate data signature streams are considered until the match fails. Thus, only the candidate data signature stream is correlated against until there is no longer a match.

The parameters of the audio acquisition (sampling rate, sampling duty cycle, quiescent time between sampling periods, volume, filter parameters, etc) and even the algorithm in use, can be adjusted dynamically by the MCD 101 or by the NOC 106. These adjustments may be a function of location information downloaded to the MCD 101 from the NOC 106 in advance or in near real-time based on current location. These adjustments are performed to increase matching accuracy, minimize data transmission, minimize MCD 101 battery drain, and for other system performance optimizations. For example, if uploading of data signatures can be carried out close to real-time, and the NOC has “locked on” to a matching signal, the MCD 101 may be instructed to lower its sampling duty cycle or to suspend sampling for some period of time.

In one embodiment, media monitors 111 monitor media sources for broadcast candidate media content items 121 (also referred to as reference media items). Each media monitor 111 can be implemented, for example, as a personal computer with a number of tuner cards that can pick up broadcasts. In one embodiment, each media monitor 111 includes four tuner cards, each capable of receiving AM, FM, or television audio signals. An example of the type of tuner card that can be used for implementing the present invention is the ASI8712 or ASI8713 eight-tuner broadcast adapter available from AudioScience, Inc. of New Castle, Del. In one embodiment, several media monitors 111 are provided, running in different locations so as to be able to pick up different markets/stations, and also to provide improved reliability and redundancy. Media monitors 111 can be configured, for example, to simultaneously receive 32 channels in parallel, taking audio components audio only, and to convert the received audio into digital form via sampling. In one embodiment, media monitors 111 are located in a location that is remote with respect to NOC 106 (for example, in a location suitable for receiving candidate media 121); media monitors 111 then transmit signals to NOC 106 via the Internet or by other mans. In another embodiment, media monitors 111 are located at NOC 106.

Transformation server 112 transforms detected candidate media content items 121 to candidate data signature streams, which are then stored at data signature stream store 114 (or at a different stream store, not shown). In one embodiment, only audio is transformed, although one skilled in the art will recognize that the present invention can also be used in connection with video, and that video transforms can thus be applied as well. The transformation converts the raw samples into data files (referred to as signature files or signature streams) that can be compared against other signature files to determine matches.

In addition, in one embodiment, transformation server 112 also transforms candidate media content items from non-broadcast reference media 113 such as audio CDs, video game sound tracks, movie sound tracks, and the like.

In an alternative embodiment, individual media monitors 111 transform audio into signature files, and transmit the signature files to server 112.

In one embodiment, servers 112 and 107 are implemented as a single server for collecting data from both MCDs 101 and media monitors 111. One skilled in the art will recognize that the present invention can be implemented using separate dedicated servers for these two functions, or using a single server that performs both functions.

In one embodiment, raw audio files (for example in .WAV format) are stored in addition to signature files. These can be stored at media monitors 111 or at a storage location associated with server 112.

In one embodiment, reference media signature files are broken up into fixed-time increments (such as five-minute increments) for ease of indexing, handling, and comparison. Thus, individual signature files are stored in stream store 114, each signature file representing five minutes of data for one audio channel. In one embodiment where raw audio is stored, the raw audio files are also broken up into fixed-time increments (such as five-minute increments). As an alternative to fixed-time divisions, some other form of intelligent time-based division can be used; for example, blank areas can be detected and interpreted as indicating breaks between commercials, and files can be divided up according to such commercial breaks.

Accordingly, in one embodiment, media monitors 111 transmit data (either in raw form or in signature form) to server 112 on a periodic basis. Data can be transmitted, for example, in five-minute increments, so that one file is transferred in each transmission. Alternatively, a number of files can be collected at receivers 111 and then transmitted to server 112 in batch form. In one embodiment, media monitors 111 retain raw audio files for some period of time (such as 3-5 days) and then discard them. In one embodiment, server 112 retains signature files for some period of time (such as 30 days) and then discards them. By retaining signature files, the present invention enables detection of user exposure to time-shifted media content items. For example, if a user is watching a television show at a time other than the broadcast time (for example, if the show was recorded on a TiVo or other video recording device), the present invention is able to detect such activity and can report that the show was recorded and at what time it was watched.

Candidate media sources can include any type of media that has an audio component detectable by MCD 101, whether from a broadcast source or a non-broadcast source. Examples include television (broadcast, cable, satellite, etc.), radio (broadcast, cable and satellite, etc.), recorded music (CD, mp3, etc.), video-game audio, movie trailers, an audio track of a DVD, and other media sources.

In an alternative embodiment, the present invention can detect user exposure to visual media such as billboards, for example by determining, based on a GPS reading on a user's location, that the user is driving past a billboard. Such media exposure events can be tracked and correlated with purchases in the same manner as exposure to audio media items, as described herein. In one embodiment, such exposure can be tracked along with exposure to audio media items, so as to obtain a complete overview of the effectiveness of an advertising campaign that includes billboard, radio advertisements, and the like.

On a periodic basis (for example, every three hours), server 112 or 112A sends signature data from stream store 114 to correlator server 115 (which may include a single server or any number of servers). In one embodiment, server 115 makes a periodic request for data from server 112 or 112A, and from data signature stream collection server(s) 107. In one embodiment, in response to the request, server 112 or 112A sends signature files representing media items collected by receivers 111, as well as data from MCDs 101 collected by data signature stream collection server(s) 107.

Correlator server 115 identifies user exposure to candidate media items including broadcast items and non-broadcast items. In one embodiment, time stamps stored with the data signatures in stream store 114 aid in the correlation.

In one embodiment, location information is collected by location tracking server 109 and used to assist in the correlation. For example, correlator server 115 can recognize that there is a lower probability of TV viewing while moving. Some behaviors that can be inferred using location information include: driving in a car (using speed range and route tracking against a road map), riding in a bus (using bus routes with frequent stops), visits to retail locations (using coordinates of retail establishments), presence at home, and presence at the workplace. Some locations influence the correlation algorithm. For example, radio and CDs in the database are checked before television if the user is moving; television is checked first while the user is at home.

Additional useful correlations and analyses can also be performed, for example to ascertain particular listening behaviors. For example, purchasing tracking server 117 can collect purchase information from sources 116 for use in assisting correlation server 115. In one embodiment, this is accomplished by tracking the use of a particular credit card that is in the possession of the user. Purchase behavior, at least to the resolution of store and amount is available from the credit card issuer. Other methods for collecting this data may include use of an RFID tag and/or a barcode on the MCD 101.

The present invention is also able to track exposure to entertainment (such as movies), whether such exposure takes place in a movie theater, at home, or elsewhere. Exposure to promotional advertisements can be correlated with exposure to movies and the like. The present invention can also help to determine which promotional channels are most effective in reaching users and which channels are less effective.

For example, in one embodiment, advertisements are given a unique ID. In addition, advertisements are assigned one or more attributes describing the goods or services being advertised at some level of specificity ranging from narrow (“Ford Mustang”) to more broad (“Ford”) to even more broad (“automobile”). A Ford Mustang advertisement will have all three of these attributes. Attributes may also describe the target audience, such as “professional.”

Tallies are kept for each attribute during a sliding window of time, for example 30 days. Purchase information can be acquired from the use of a credit card issued to panel members, through retailer reporting, through survey, or from other sources.

When a user makes a purchase of an item being tracked, related tallies for that user over some period of time (such as the past 30 days) is examined. With a sufficiently large set of users, correlations are made between purchase behavior and media exposure. This is done, for example, by comparing the media exposure of the purchaser of product A with the media exposure of the purchaser of competing product B.

The tracking methods provided by the present invention facilitate measurement of the effectiveness of advertisements in attracting consumers who otherwise would purchase competing brands, as well as attracting consumers who otherwise would not buy the product or product type at all. In addition, the present invention is able to measure the effect an advertisement has on consumption of brands other than the advertised brand.

Using the correlation between purchase behavior and media exposure may show, for example, that people exposed to Ford Mustang commercials have a higher propensity to buy Ford Thunderbirds if they are not exposed to many non-Ford automobile ads.

Given the raw data of purchase behavior and attribute exposure tallies, database queries can be performed to reveal causal relationships and to test advertising hypotheses.

Other sources of data that can be used and stored include an RFID tag, GPS tracking information, and/or a barcode on MCD 101, so as to assist in location tracking. In one embodiment, Bluetooth transceivers can be installed in certain locations, and location tracking is performed by detection of unique Bluetooth transceiver codes.

From these various types of data, patterns can be deduced. For example, the system of the present invention can determine that a user watches news at home and listens to music in the car, or can infer purchasing behavior such as a pattern where the user visits a movie theater after listening to an ad for one of the movies playing at that theater.

Additional components can be used in generating reports on media exposure and consumption. A time-based history of user exposure to media items is stored in consumer tracking database 118. Location information is also stored, if available.

Analytical reporting server 119 uses consumer tracking data from database 118 to generate reports 120. Reports can include, for example:
advertisement play rates;
program ratings;
metrics of marketing effectiveness;
psychographic classifications;
and the like.

In one embodiment, reports are generated using standard relational-database queries. Results of these queries can be place in tabular or graphical format for presentation.

After all correlations are complete, live media source data signatures may be discarded.

Using the above-described techniques, the system of the present invention is able to measure media exposure both in and out of the home.

### Alternate Configurations

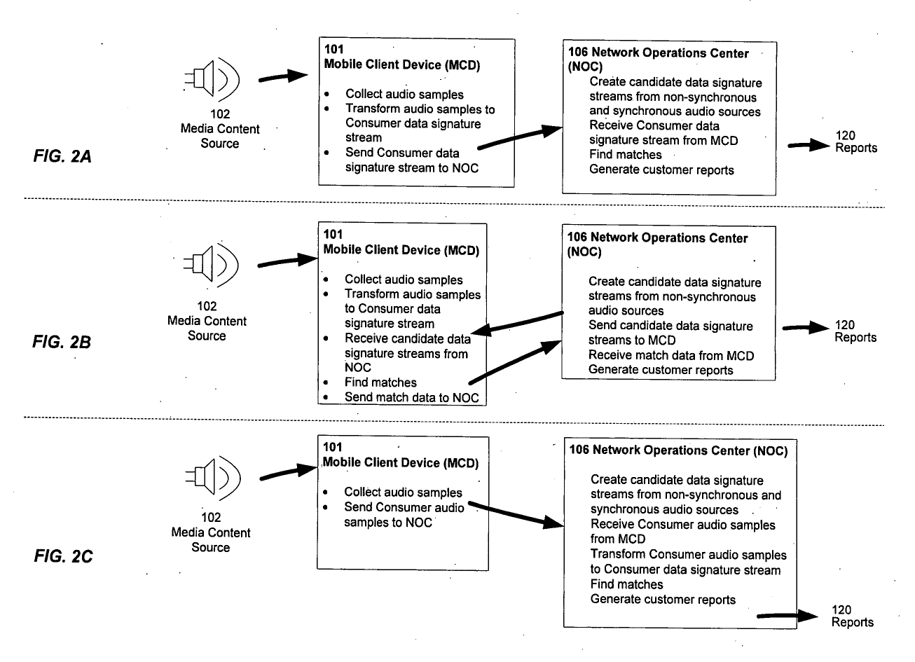

One skilled in the art will recognize that the transformation and matching steps can be performed in many different ways and at different components within the overall system. FIGS. 2A through 2C provide examples of different configurations for performing these functions. These Figures also provide a description of the overall method of operation of the present invention according to various embodiments.

Referring now to FIG. 2A, there is shown a configuration where transformation takes place at MCD 101 and matching takes place at NOC 106. As described above, MCD 101 collects audio samples, transforms them to a signature stream, and transmits the signature stream to NOC 106. NOC 106 identifies matches between signature stream received from MCD 101 and streams derived from media 113 and 121.

Referring now to FIG. 2B, there is shown a configuration where transformation and matching both take place at MCD 101. Here, MCD 101 collects audio samples and transforms them to a signature stream. NOC 106 generates candidate data signature streams from candidate media, and transmits these candidate streams to MCD 101. MCD 101 then identifies matches between the signature stream it generated from incoming audio data and the candidate data signature streams received from NOC 106. MCD 101 then sends match data to NOC 106. This configuration is particularly useful when the number of candidate audio sources is relatively small and known in advance. For example, such a configuration can be used for monitoring a user's exposure to a limited and expected set of advertisements. In such a situation, this configuration reduces the amount of data that is continually transmitted from MCD 101 to NOC 106; once the set of candidates is provided to MCD 101, only match data need be transmitted, which typically requires less bandwidth than transmission of signatures from MCD 101 to NOC 106. Such a configuration is also a more distributed processing paradigm that can serve to reduce processor load at NOC 106, since NOC 106 need not perform matching operations for a large number of MCDs; rather MCD 101s do their own matching.

Referring now to FIG. 2C, there is shown a configuration where transformation and matching both take place at NOC 106. Here, MCD 101 collects audio samples and transmits the raw data to NOC 106. NOC 106 transforms the raw data to a signature stream and then identifies matches between the signature stream and the candidate data signature streams. This configuration reduces the processing load on MCD 101.

In any of these configurations, NOC 106 can optionally inform MCD 101 to only sample audio at specific time periods. In this way, MCD 101 sample period may be limited to commercial time periods, or other periods of interest.

In an alternative embodiment, MCD 101 stores feature-extracted samples. When MCD 101 detects (hears) an advertisement or other sought-for audio, it reports back to NOC 106 that it heard the item. In one variation of this embodiment, MCD 101 does not need to transmit any transformed audio back to NOC 106, but simply reports and identifies the item that was heard. In another variation of this embodiment, MCD 101 transmits additional information about the detected audio, such as time and place where it was detected. In yet another variation, MCD 101 transmits the transformed audio (or some subset of it) to NOC 106, so that additional information can be derived from the detected audio.

In another alternative embodiment, the invention operates at a variable sample rate depending on the amount of usage that is detected. A default, lower sample rate is used when the usage pattern is continuous and/or relatively stable. A higher sample rate is used when changes in usage pattern are detected. In one variation of this embodiment, MCD 101 switches automatically between these rates in response to changing conditions. Any number of different sample rates, or continuous variation within a defined range, can be used.

### Data Signature Algorithm

In one embodiment, the present invention performs audio data signature transformation according to any of a number of well-known algorithms. Preferably, an algorithm is used that meets the processing power, memory size, battery life, and bandwidth constraints of MCD 101, and also meets a minimum accuracy requirement. The audio data signature transformation algorithm finds matching audio streams in broadcast audio signals, known to be transmitted at a certain time, and asynchronous audio signals such as music tracks and video game sound tracks.

The algorithm can be based in the time-domain, based in the frequency-domain, or based in a hybrid of the two.

In one embodiment, the audio data signature transformation algorithm correlates a consumer data signature stream (target media items) against a potentially large number of candidate data signature streams (reference media items). Once a match is found, it can be presumed the match continues for some period of time. In one embodiment, only the candidate data signature stream is correlated against until there is no longer a match. In other words, when a match is found, it is “locked on to” and no other candidate data signature streams are considered until the match fails.

In one embodiment, the system of the present invention uses a signature transformation algorithm such as Shazam, described in Wang et al. and available from Shazam Entertainment Ltd., of London, England. This algorithm is also described in Avery Li-chun Wang, “An Industrial-Strength Audio Search Algorithm,” October 2003, and Avery Li-Chun Wang and Julius O. Smith, III, WIPO publication WO0211123A3, 7 Feb. 2002, “Method for Search in an Audio Database.” The signature transformation algorithm generates a 4 k file that is spooled (temporarily stored) at MCD 101. In one embodiment, MCD 101 erases the raw audio file once the signature file has been created; in another embodiment, raw audio is saved for some period of time for testing purposes.

In one embodiment, the parameters of the audio acquisition (sampling rate, sampling duty cycle, quiescent time between sampling periods, volume, filter parameters, and the like), and even the algorithm in use, can be adjusted dynamically by MCD 101 and/or by NOC 106. These adjustments may be a function of location information downloaded to MCD 101 from NOC 106 in advance or in near real-time based on current location. These adjustments are performed, for example, to increase matching accuracy, minimize data transmission, minimize MCD 101 battery drain, and for other system performance optimizations. For example, if uploading of data signatures can be carried out close to real-time, and NOC 106 has “locked on” to a matching signal, MCD 101 may be instructed to lower its sampling duty cycle or to suspend sampling for some period of time.

### Advertisement Detection and Tracking

In one embodiment, the present invention tracks broadcasts of advertisements (flighting) and/or user exposure to advertisements. Advertisements are identified, signatures are generated, and media streams are compared with the advertisement signatures in order to tracking flighting and/or user exposure. Particular techniques for implementing such functionality are described below.

Data signatures generally correlate to unique events from the monitored audio sources. Advertisements can be identified by virtue of certain unique characteristics: for example, they are often of fairly short duration and are run frequently and across many channels. Accordingly, media items that follow such a pattern can be identified as advertisement candidates. In one embodiment, as described below, such advertisement candidates are presented to a human operator who can indicate whether or not the candidates are in fact advertisements, and who can also provide additional useful information about the content of the advertisements.

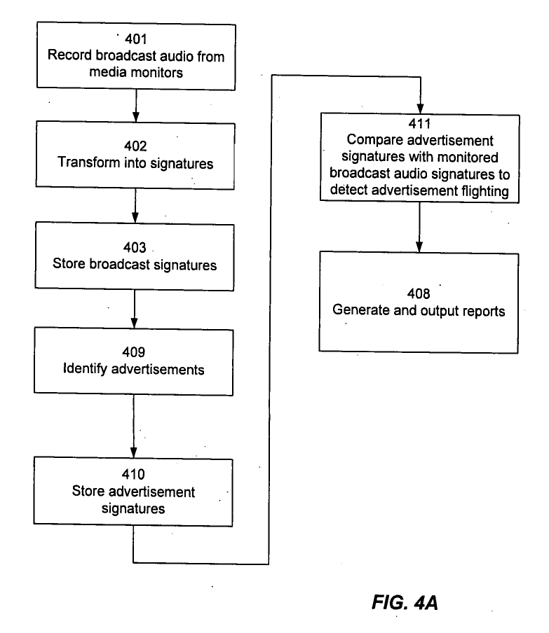

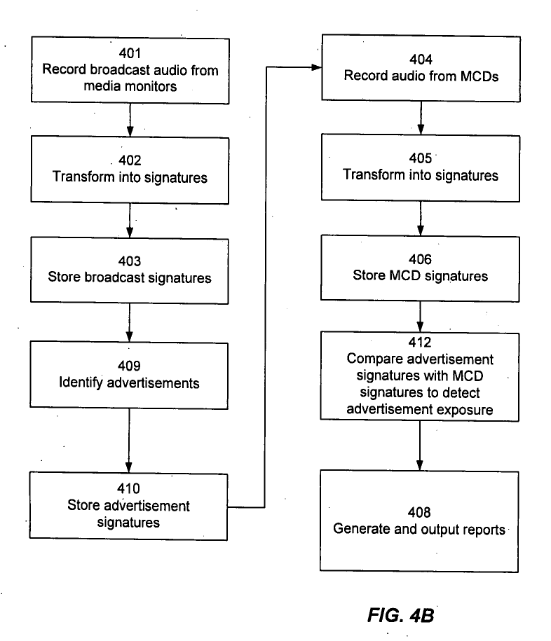

Referring now to FIG. 4A, there is shown a method for detecting and tracking advertisements by comparison with broadcast audio signatures according to one embodiment of the present invention. Broadcast audio from media monitors 111 is recorded 401. In one embodiment, media monitors 111 also detect audio from non-broadcast sources; alternatively, audio from non-broadcast sources can be supplied by other means such as by extraction from a DVD or CD. The broadcast (and non-broadcast) audio is transformed 402 into signatures, and the signatures are stored 403. Advertisements are identified 409, according to techniques described below, and signatures for the identified advertisements are stored 410. As will be described in more detail below, tags can be attached to the stored advertisement signatures. Once a repository of signatures for identified advertisements has been created, monitored broadcast audio is compared 411 with these stored advertisement signatures, in order to detect broadcasts (flighting) of advertisements. Reports are generated and output 408 based on the results.

Referring now to FIG. 4B, there is shown a method for detecting and tracking advertisements by comparison with signatures obtained from mobile client devices according to one embodiment of the present invention. Steps 401 through 410 are identical to those of FIG. 4A. Once a repository of signatures for identified advertisements has been created, audio from MCDs 101 is recorded 404 and transformed 405 into signatures. These MCD signatures are stored 406 and compared 412 with stored advertisement signatures, in order to detect user exposure to advertisements. Reports are generated and output 408 based on the results.

Additional details concerning the particular steps shown in FIGS. 4A and 4B are provided below.

Identifying Advertisements

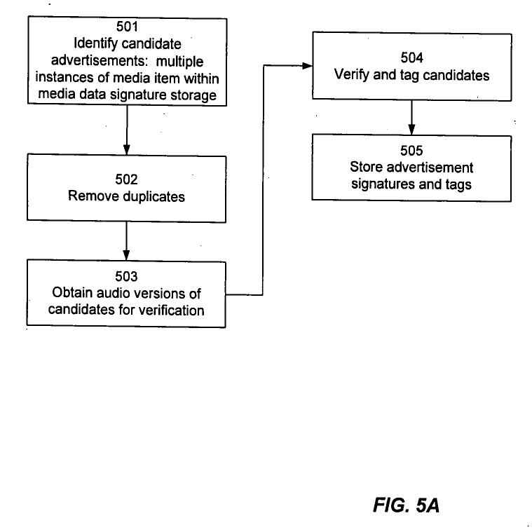

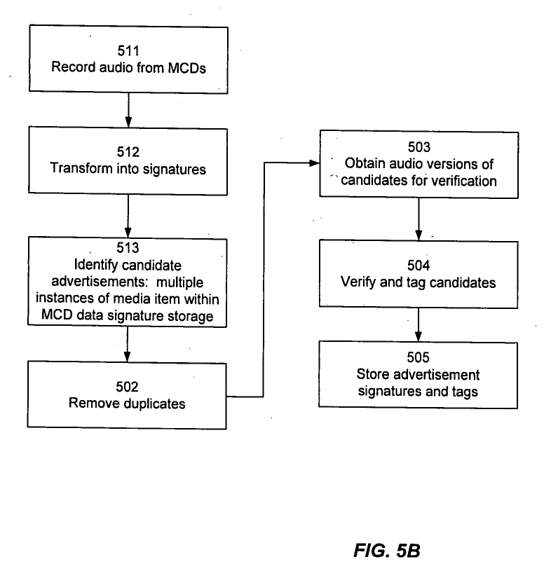

Referring now to FIGS. 5A and 5B, there are shown two methods for identifying advertisements according to the present invention. In one embodiment, as shown in FIG. 5B, the system of the present invention determines advertisement candidates by correlating MCD data signatures (obtained from MCDs 101 carried by users and stored in storage 301) against media data signatures stored in media data signature storage 114. Audio from MCDs 101 is recorded 511 and transformed 512 into signatures. Advertisement candidates are identified 513 based on multiple instances of a media item within MCD data signature storage 301. Advertisement candidates that are duplicates of previously identified advertisements are removed 502. Audio versions of advertisement candidates are obtained 503. The advertisement candidate (along with the obtained audio version) is presented to an operator for verification and tagging 504. Verified advertisements signatures and tags are then stored 505.

In another embodiment, as shown in FIG. 5A, the system of the present invention determines advertisement candidates by correlating media data stored in media data signature storage 114 against itself, either within a particular media channel or across channels. Broadcast audio is analyzed to identify 501 advertisement candidates based on multiple instances of a media item within media data signature storage 114. Audio from non-broadcast sources (such as movie trailers) can also be analyzed in this manner. Advertisement candidates that are duplicates of previously identified advertisements are removed 502. Audio versions of advertisement candidates are obtained 503. The advertisement candidate (along with the obtained audio version) is presented to an operator for verification and tagging 504. Verified advertisements signatures and tags are then stored 505.

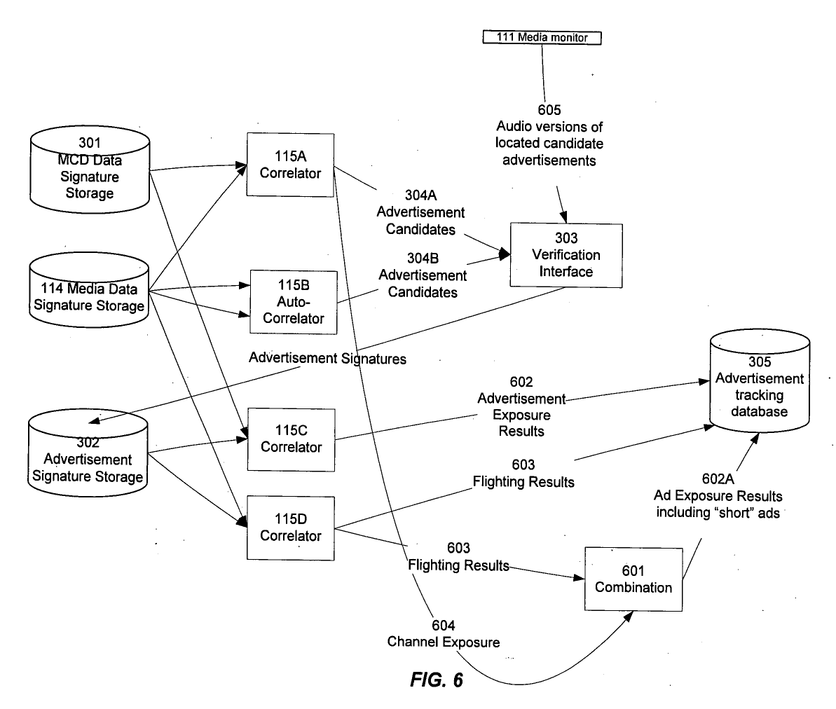

The methods of FIGS. 5A and 5B are now described in more detail with reference to FIG. 6. FIG. 6 depicts various mechanisms for identifying, detecting, and tracking advertisements according to various embodiments of the present invention. The components and mechanisms shown in FIG. 6 can be implemented singly or in any combination.

Correlator 115A finds correlations between MCD data signatures and media data signatures, and identifies media items that appear repeatedly. Correlator 115B finds correlations among media data signatures, and identifies media items that appear repeatedly. Repeated occurrences of a media item, particularly across more than one channel, indicate that the media item is likely to be an advertisement. Accordingly, correlator 115A identifies such media items as advertisement candidates 304B and presents them to a verification interface 303 for verification. In one embodiment, the time of occurrence and channel for each instance of advertisement candidates 304B are stored in a database. In addition, in one embodiment, audio versions 605 of advertisement candidates 304B (captured by media monitor 111) are also stored.

In one embodiment, verification takes place by human interaction with a system via verification interface 303. Each advertisement candidate 304B is presented to an operator, and the operator indicates whether or not the candidate 304B is in fact an advertisement. In one embodiment, the operator can refer to the audio version 605 of the advertisement candidate 304B in order to determine whether or not the candidate 304B is an advertisement. The operator can trim the audio file associated with the advertisement, using an audio editing program, so as to remove extraneous material, for example taking place before or after the advertisement itself. In one embodiment, in addition to indicating that a candidate 304B is an advertisement, the operator can tag the advertisement with a name or label, as well as additional useful information, such as category, product being advertised, length of the advertisement, and/or other information.

Once the advertisement candidate 304B has been verified as being an advertisement, a signature file is generated for the advertisement. The signature file is correlated to existing advertisement signature files in the advertisement signature storage 302. The operator is alerted if the advertisement has a high correlation with any previously stored advertisements. The operator can listen to the audio versions of any stored advertisements as an aid in determining, and eliminating, duplicates.

If the newly identified advertisement is not a duplicate of any previously-stored signature file, the new signature is stored in advertisement signature storage 302. If the operator specified any tags further describing the advertisement, the tags are stored in storage 302 along with the signature. An audio version of the advertisement can also be stored, for example in MP3 format, for later reference by the operator. In one embodiment, a speech recognition module (not shown) detects spoken words in the advertisement and generates a textual representation of the spoken words. This textual representation can also be stored and associated with the advertisement signature. Optionally, the textual representation can be presented to an operator for verification of its accuracy and for editing if required. Alternatively, the operator can generate the textual representation (or some other text-based summary of the advertisement contents) as one of the tags for the advertisement.

If the new advertisement is a duplicate, the operator can still add or modify tags if desired, in order to better describe the content of the advertisement.

Tracking Advertisement Flighting and Exposure

Once advertisements have been identified and their signatures stored in storage 302, these signatures can be used for tracking and measuring advertisement flighting and exposure.

In one embodiment, incoming media signature streams received from broadcast media 121 via media monitors 111 are compared with advertisement signatures stored in storage 302 to find occurrences of advertisements and thereby determine times and dates at which advertisements were broadcast. Media signature streams from non-broadcast media are analyzed in a similar manner, so that flighting can be determined in both broadcast and non-broadcast contexts. In one embodiment, previously saved signature streams can also be compared with advertisement signatures stored in storage 302 to find past flighting of identified advertisements. In this manner, past and/or present advertisement impressions can be identified and tracked; the system of the present invention can even discover the first time an advertisement ran on the monitored media.

In another embodiment, incoming media signature streams received from MCDs 102 are compared with advertisement signatures stored in storage 302 to find occurrences of advertisements and thereby determine times and dates at which users were exposed to advertisement. In one embodiment, previously saved signature streams from storage 301 can also be compared with advertisement signatures stored in storage 302 to find past exposure to identified advertisements. By identifying particular users having MCDs 102 that were exposed to the advertisements, and by correlating such exposed users to known demographic data, the system of the present invention can help identify demographics of users/consumers that were exposed to advertisements.

Referring again to FIG. 6, correlator 115D compares media data signatures stored in storage 114 with advertisement signatures stored in storage 302 to generate flighting results 603 that indicate times and dates at which an advertisement appeared. Correlator 115C compares MCD 102 data (from storage 301) with advertisement signatures stored in storage 302 to generate advertisement exposure results 602. Either or both of these results are stored in advertisement tracking database 305 so that reports, statistics, and the like can be generated and displayed.

As mentioned above, in one embodiment audio at MCDs 101 is sampled at for example ten seconds every thirty seconds. Accordingly, correlators 115A and 115C that use data from MCDs 101 are able to identify advertisements and measure exposure even when only a portion of the advertisements appears in the data obtained from MCDs 101. In some situations, however, an advertisement may be relatively short in duration, so that it is broadcast in the time period between MCD samples. In such a situation, no portion of the advertisement appears in MCD data stored in storage 301. However, the present invention can still infer that a user was exposed to the advertisement by determining that a) the advertisement aired on a particular channel at a particular time, based on flighting results 603 obtained from correlator 115D, and b) the user was listening to that channel just before and/or just after the advertisement aired, based on a determination of channel exposure 604 derived from correlator 115A comparing MCD data from storage 301 with media data from storage 114. The combination 601 of flighting results 603 and channel exposure 604 provides sufficient information to reliable infer advertisement exposure results 602A including short advertisements that ran between MCD samples. Such a technique is particularly effective in implementations where correlator 115 “locks on” to a matching signal when a match is found, as described above.

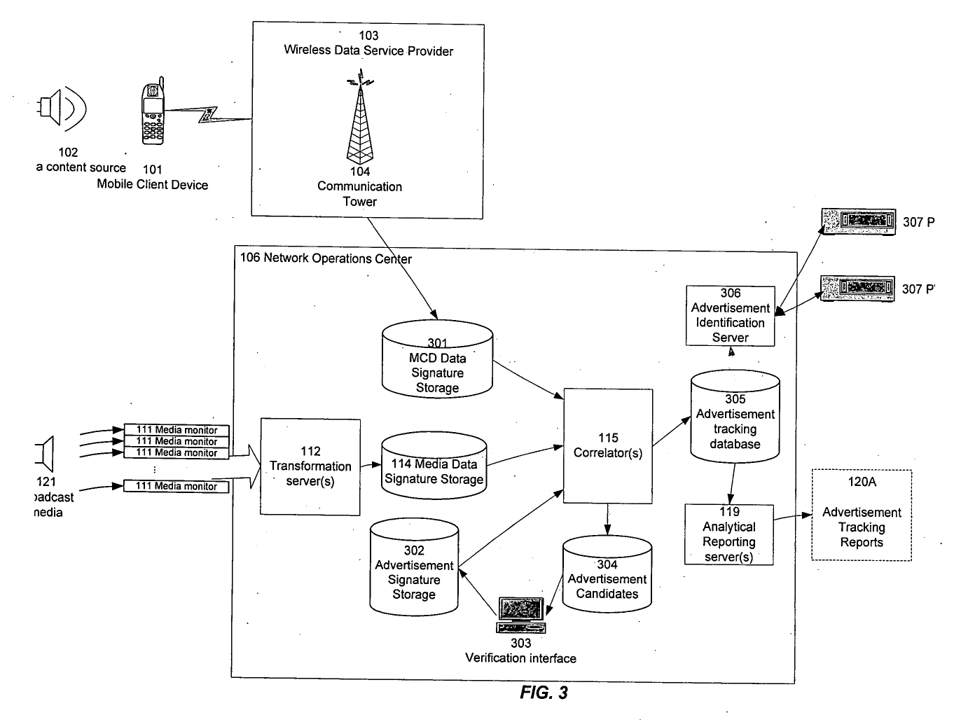

Referring now to FIG. 3, there is shown a block diagram depicting an architecture for detecting and tracking advertisements according to one embodiment of the present invention. FIG. 3 shows some of the functional components of FIG. 6, but also shows how such components fit within the context of the overall system.

MCDs 101 detect audio data from media content sources 102. MCDs 101 transmit data (which may already be converted into signatures) via wireless data service provider 103 to NOC 106. NOC 106 stores data signatures in MCD data signature storage 301. Media monitors 111 monitor broadcast media 121; transformation server(s) 112 transform the monitored audio into signatures which are stored in media data signature storage 114. In one embodiment the transformation takes place at media monitors 111; in another embodiment, it takes place at NOC 106. In one embodiment, media monitors 111 also store a local copy of the audio data (for example, in WAV format) for a period of time, such as a few days.

Correlator(s) 115 correlate data from storage 301 with data from storage 114, and/or data from storage 114 with itself, according to techniques described above in connection with FIG. 6. Correlator(s) 115 identify advertisement candidates 304 which an operator verifies using verification interface 303, as described above. Advertisement signatures are stored in storage 302 based on such verification.

Correlator(s) 115 store results of advertisement tracking and exposure in database 305. Analytical reporting server(s) 119 use data from database 305 to generate advertisement tracking reports 102A.

In one embodiment, advertisement identification server 306 provides data describing times, dates, and channels for flighting of advertisements. Such data can be used in many different ways. For example personal video recorders (PVRs) 307 or other video/audio recording devices can obtain such flighting information from server 306 and thereby remove advertisements from recorded programs or other media. The advertisements can be deleted, skipped over, sped up, or the like. Certain ads, depending on content or other factors, can be let through, for example if the user is interested in seeing one type of ad but not another.

In such a context, the results from database 305 need not be real-time. The channel and time-stamp of all commercials can be made available at a web server on the Internet (in XML or other format), so as to facilitate skipping of advertisements when the media is watched or listened to, even if this is much later than the actual broadcast of the media. In one implementation, near real-time information is available.

In another embodiment, after advertisements are identified, advertisements signatures are downloaded to PVRs 307. Each PVR 307 runs a signature algorithm to find and stamp out commercials, potentially in real-time.

In another context, data from advertisement identification server 306 can be used to identify times and channels for advertisements the user would like to see. Accordingly, the user can use such data to call up and view (or listen to) an advertisement that was previously recorded. For example, a user can enter “SUV”. The PVR 307 (or other device) contacts NOC 106 to locate channels which have been recently airing SUV advertisements. PVR 307 captures SUV advertisements from one or more channels, or downloads the advertisements directly from NOC 106.

One skilled in the art will recognize many other applications for data in server 306.

In one embodiment, when correlator 115 identifies advertisement candidates, a media monitor 111 that has an audio copy of the advertisement candidate is instructed to upload that audio data file to NOC 106 where it is stored for use by the operator in verifying (via interface 303) whether or not the candidate is an advertisement. In one embodiment, media monitor 111 compresses the audio in a format such as MP3 before transmitting the audio to NOC 106. In one embodiment, some additional time before and after the advertisement candidate is included, both to ensure that the entire advertisement is captured and also to provide context.

In one embodiment, the present invention is used for identifying media that includes a video component, for example television commercials. In such an embodiment, video can be stored at media monitor 111; when needed, the video is provided to NOC 106 so that the operator can view the video of the advertisement candidate to assist in its identification and categorization via interface 303.

In one embodiment, data from user exposure to advertisements is used for generating reports 120A. Additional applications are also available. For example, a time-based history of media exposure for each user is stored in a database. Location information is also stored. The user is given a credit card to be used for making all purchases. Consumer purchasing information, available from this credit card or from other sources, is also stored. Other sources may include an RFID tag and/or a barcode on the MCD 101. The data is analyzed and sold, for example in aggregate with other users of matching demographic or psychographic attributes, to advertisers, advertising agencies and other entities involved in the creation or distribution of audible or billboard content.

One skilled in the art will recognize that the present invention can be used with any type of media item that includes an audio component. Examples include television (broadcast, cable, satellite, etc.), radio (broadcast, cable and satellite, etc.), recorded music (CD, mp3, etc.), video game audio, DVD audio, movie trailers, movie soundtracks and other media sources. In one embodiment, the system measures media exposure both in and out of the home. Some behaviors that can be inferred using location information include: driving in a car (using speed range and route tracking against a road map), riding in a bus (using bus routes with frequent stops), visits to retail locations (using coordinates of retail establishments), presence at home, and presence at the workplace. Some locations influence the correlation algorithm. For example, radio and CDs in the database are checked before television if the user is moving; television is checked first while the user is at home. A Blue-tooth, or other transmitter, transmitting a unique signal can be placed in the user's home allowing an MCD 101 capable of receiving the signal, to determine whether or not it is located at the user's home.

What is claimed is:

1. A method for tracking flighting of advertisements, comprising:
recording at least one audio stream;
identifying at least one advertisement within the recorded at least one audio stream;
for each identified advertisement, generating an advertisement signature;
monitoring at least one audio stream, each audio stream corresponding to a channel;
comparing the at least one monitored audio stream with the generated at least one advertisement signature; and
responsive to the comparison, identifying at least one time at which an advertisement was presented.

2. The method of claim 1, wherein recording at least one audio stream comprises recording audio from a broadcast source.

3. The method of claim 1, wherein recording at least one audio stream comprises recording audio from a non-broadcast source.

4. The method of claim 1, wherein recording at least one audio stream comprises recording audio from a mobile client device.

5. The method of claim 1, further comprising:
for each identified time at which an advertisement was flighted, identifying a channel on which the advertisement was flighted.

6. The method of claim 1, further comprising:
generating a report indicating the identified at least one time at which an advertisement was flighted.

7. The method of claim 1, wherein identifying at least one advertisement comprises:
identifying, as an advertisement, a media item repeated at least a predetermined number of times.

8. The method of claim 1, wherein identifying at least one advertisement comprises:
identifying, as a potential advertisement, a media item repeated at least a predetermined number of times;
presenting the potential advertisement for verification; and
receiving input indicating whether the potential advertisement is an advertisement.

9. The method of claim 8, wherein receiving input indicating whether the potential advertisement is an advertisement comprises:
receiving input from a user.

10. The method of claim 8, further comprising receiving input indicating at least one property of the advertisement, and storing a record associating the advertisement with the indicated property.

11. The method of claim 10, wherein the indicated property comprises a product being advertised.

12. The method of claim 10, wherein the indicated property comprises a service being advertised.

13. The method of claim 10, wherein the indicated property comprises a source of the advertisement.

14. The method of claim 10, wherein the indicated property comprises an indication of the content of the advertisement.

15. The method of claim 1, wherein identifying at least one advertisement comprises:
identifying, as a potential advertisement, a media item repeated at least a predetermined number of times;
determining whether the potential advertisement has previously been identified as an advertisement; and
responsive to the potential advertisement not being previously identified as an advertisement:
presenting the potential advertisement for verification; and
receiving input indicating whether the potential advertisement is an advertisement.

16. The method of claim 1, wherein:
recording at least one audio stream comprises recording at least two audio streams; and
identifying at least one advertisement comprises identifying, as an advertisement, a media item repeated at least a predetermined number of times within at least a predetermined number of audio streams.

17. The method of claim 1, wherein:
monitoring at least one audio stream comprises monitoring audio from a broadcast source.

18. The method of claim 1, wherein:
monitoring at least one audio stream comprises monitoring audio from a non-broadcast source.

19. The method of claim 1, wherein:
monitoring at least one audio stream comprises monitoring audio from a mobile client device.

20. The method of claim 1, wherein:
monitoring at least one audio stream comprises monitoring audio from a device carried by a user.

21. The method of claim 1, wherein the audio stream comprises an audio portion of an audiovisual media item.

22. A method for identifying advertisements, comprising:
recording at least one audio stream;
identifying, as an advertisement, a media item repeated at least a predetermined number of times.
for each identified advertisement, generating an advertisement signature; and
storing each generated advertisement signature.

23. The method of claim 22, wherein recording at least one audio stream comprises recording at least one broadcast audio stream.

24. The method of claim 22, wherein:
recording at least one audio stream comprises recording at least two audio streams; and
identifying at least one advertisement comprises identifying, as an advertisement, a media item repeated at least a predetermined number of times within at least a predetermined number of audio streams.

25. The method of claim 22, further comprising:
recording a media item,
comparing at least a portion of the media item with the at least one stored advertisement signature; and
in response to detection of an identified advertisement, suppressing the identified advertisement.

26. The method of claim 25, wherein suppressing the identified advertisement comprises:
deleting the identified advertisement from the recorded media item.

27. The method of claim 25, wherein suppressing the identified advertisement comprises:
skipping over the identified advertisement in the recorded media item.

28. The method of claim 25, wherein suppressing the identified advertisement comprises:
tagging the beginning and end of the identified advertisement in the recorded media item.

29. The method of claim 25, wherein suppressing the identified advertisement comprises:
pausing the recording at the beginning of the identified advertisement; and
restarting the recording at the end of the identified advertisement.

30. A method for identifying advertisements, comprising:
recording at least one audio stream;
identifying, as a potential advertisement, a media item repeated at least a predetermined number of times.
presenting the potential advertisement for verification;
receiving input indicating whether the potential advertisement is an advertisement;
for each potential advertisement indicated as an advertisement, generating an advertisement signature; and
storing each generated advertisement signature.

31. A method for tracking user exposure to advertisements, comprising:
recording at least one audio stream;
identifying at least one advertisement within the recorded at least one audio stream;
for each identified advertisement, generating an advertisement signature;
monitoring at least one audio stream, each audio stream corresponding to a user;
comparing the at least one monitored audio stream with the generated at least one advertisement signature; and
responsive to the comparison, identifying at least one time at which the user was exposed to an advertisement.

32. The method of claim 31, wherein:
monitoring at least one audio stream comprises monitoring audio from a device carried by the user.

33. The method of claim 31, wherein:
monitoring at least one audio stream comprises sampling the audio stream.

34. The method of claim 31, wherein:
monitoring at least one audio stream comprises recording portions of the audio stream; and
comparing the at least one monitored audio stream with the generated at least one advertisement signature comprises comparing at least one recorded portion of an audio stream with the generated at least one advertisement signature.

35. A method for tracking user exposure to an advertisement, comprising:
obtaining at least one advertisement signature;
monitoring at least one user audio stream, each user audio stream corresponding to a user, by recording portions of the user audio stream;
monitoring at least one broadcast audio stream, each broadcast audio stream corresponding to a channel;
comparing the at least one monitored broadcast audio stream with the at least one advertisement signature;
responsive to the comparison, identifying at least one time at which an advertisement was presented on a channel;
detecting user exposure to the channel on which the advertisement was presented; and
outputting an indication that the user was exposed to the advertisement.

36. The method of claim 35, wherein obtaining at least one advertisement signature comprises:
recording at least one audio stream;
identifying at least one advertisement within the recorded at least one audio stream; and
for each identified advertisement, generating an advertisement signature;

37. The method of claim 35, wherein recording portions of the user audio stream comprises recording portions of audio detected at a mobile client device associated with the user.

38. The method of claim 35, wherein detecting user exposure to the channel on which the advertisement was presented comprises detecting user exposure to the channel at a time other than the time at which the advertisement was presented.

39. The method of claim 38, wherein the advertisement was presented during a non-recorded portion of the user audio stream.

40. A system for tracking flighting of advertisements, comprising:
at least one media monitor, for recording at least one audio stream;
an advertisement identifier, for identifying at least one advertisement within the recorded at least one audio stream;
an advertisement signature storage device, for storing an advertisement signature for each identified advertisement;
a correlator, for comparing at least one monitored audio stream with the generated at least one advertisement signature to obtain advertisement flighting results; and
an advertisement tracking database, for, responsive to the comparison, storing the advertisement flighting results including at least one record identifying at least one time at which an advertisement was presented.

41. The system of claim 40, wherein the advertisement identifier identifies, as an advertisement, a media item repeated at least a predetermined number of times.

42. The system of claim 40, wherein the advertisement identifier comprises:
a candidate identifier, for identifying, as a potential advertisement, a media item repeated at least a predetermined number of times;
an output device, for presenting the potential advertisement for verification; and
an input device, for receiving input indicating whether the potential advertisement is an advertisement.

43. The system of claim 42, wherein the input device receives input indicating at least one property of the advertisement, and wherein the advertisement signature storage device stores a record associating the advertisement with the indicated property.

44. The system of claim 40, further comprising:
at least one mobile client device associated with a user, for monitoring at least one user audio stream;
wherein the correlator compares the at least one user audio stream with the generated at least one advertisement signature to determine user exposure to advertisements.

45. A system for identifying advertisements, comprising:
at least one media monitor, for recording at least one audio stream;
an advertisement identifier, for identifying, as an advertisement, a media item repeated at least a predetermined number of times; and
an advertisement signature storage device, for storing an advertisement signature for each identified advertisement.

46. The system of claim 45, further comprising:
a recorder, for recording a media item,
an advertisement suppression module, for, comparing at least a portion of the media item with the at least one stored advertisement signature, and, in response to detection of an identified advertisement, suppressing the identified advertisement.

47. A system for identifying advertisements, comprising:
at least one media monitor, for recording at least one audio stream;
an advertisement identifier, for identifying, as a potential advertisement, a media item repeated at least a predetermined number of times.
an output device, for presenting the potential advertisement for verification;
an input device, for receiving input indicating whether the potential advertisement is an advertisement; and
a storage device for storing an advertisement signature for each potential advertisement indicated as an advertisement.

48. A system for tracking user exposure to advertisements, comprising:
at least one media monitor, for recording at least one audio stream;
an advertisement identifier, for identifying at least one advertisement within the recorded at least one audio stream;
an advertisement signature storage device, for storing an advertisement signature for each identified advertisement;
at least one client device, for monitoring at least one audio stream, each audio stream corresponding to a user; and
an advertisement exposure module, for comparing the at least one monitored audio stream with the generated at least one advertisement signature and for, responsive to the comparison, identifying at least one time at which the user was exposed to an advertisement.

49. The system of claim 48, wherein:
the client device monitors at least one audio stream by recording portions of the audio stream; and
the advertisement exposure module compares at least one recorded portion of an audio stream with the generated at least one advertisement signature.

50. A system for tracking user exposure to an advertisement, comprising:
at least one client device, for monitoring at least one user audio stream, each user audio stream corresponding to a user, by recording portions of the user audio stream;
at least one media monitor, for monitoring at least one broadcast audio stream, each broadcast audio stream corresponding to a channel;
an advertisement flighting monitor, for comparing the at least one monitored broadcast audio stream with at least one advertisement signature, and for, responsive to the comparison, identifying at least one time at which an advertisement was presented on a channel;
a channel identifier, for detecting user exposure to the channel on which the advertisement was presented; and
an output device, for outputting an indication that the user was exposed to the advertisement.

51. The system of claim 50, further comprising:
a media monitor, for recording at least one audio stream;
an advertisement identifier, for identifying at least one advertisement within the recorded at least one audio stream and for each identified advertisement, generating an advertisement signature for use by the advertisement flighting monitor.

52. The system of claim 50, the channel identifier detects user exposure to the channel at a time other than the time at which the advertisement was presented.

53. The system of claim 52, wherein the advertisement was presented during a non-recorded portion of the user audio stream.
